(19) United States
(12) Patent Application Publication
(10) Pub. No.: US 2012/0130795 A1
(43) Pub. Date: May 24, 2012

(54) ON DEMAND DISCOUNT SYSTEM AND METHODS

(76) Inventor: Mark Iacoponi, Homer Glen, IL (US)

(21) Appl. No.: 13/303,928

(22) Filed: Nov. 23, 2011

Related U.S. Application Data
(60) Provisional application No. 61/416,987, filed on Nov. 24, 2010.

(51) Int. Cl. G06Q 30/02

(52) U.S. Cl. 705/14.35; 705/14.1

(57) ABSTRACT

A discount distribution system includes a discount generation unit having a processor and a memory with a program executing in the memory that performs the steps of gathering information pertaining to a product by an information gathering unit, generating a plurality of discounts associated with the product based on the information gathered, storing each of the generated discounts and associated product information in the memory of the discount generation unit, displaying a plurality of selected discounts on a display on an initiator device in response to a triggering event, distributing at least one of the plurality of discounts to a plurality of client devices based on a request from the initiator device.

### CROSS-REFERENCE TO RELATED APPLICATIONS

The present application claims the benefit of U.S. Provisional Patent Application No. 61/416,987 titled “On Demand Discount Systems and Methods,” filed Nov. 24, 2010, the entire contents of which are incorporated herein by reference.

### FIELD OF THE INVENTION

The present invention is generally related to the distribution of discounts to a plurality of users over a network. Specifically, the present invention is directed to distributing a discount to a plurality of users in real time.

### BACKGROUND OF THE INVENTION

Countless opportunities exist for merchants to extend discounts to clients. Currently, merchants utilize many different methods of distributing a discount to consumers including e-mail, Internet banner advertisements, online services, mailings, and commercials. Merchants typically plan out different discounts based on the time of year, an upcoming event, overstocking of a particular product or the desire to draw people to the merchant's store or web site.

Typically the planning and distribution of a discount is performed by a person at a managerial level within an organization. A need exists for a system which allows non management employees to distribute a discount to clients based on the observations of the non management employee.

### SUMMARY OF THE INVENTION

Various embodiments of the present disclosure provide a discount distribution system including a discount generation unit having a processor and a memory, with a program executing in the memory that performs the steps of gathering information pertaining to a product by an information gathering unit, generating a plurality of discounts associated with the product based on the information gathered, storing each of the generated discounts, and the associated product information, in the memory of the discount generation unit, displaying each of the discounts on a display on an initiator device in response to a triggering event, and distributing at least one of the plurality of discounts to a plurality of client devices based on a request from the initiator device.

Various other embodiments include a discount management device including an information gathering unit, a discount generation unit, a discount storage unit, and a discount distribution unit, where the discount generation unit generates a discount associated with a product based on information gathered from an information gathering unit, and stores the discount in the discount storage unit, and the discount generation unit distributes at least one discount in the discount storage unit to at least one client device of a plurality of client devices in response to a request to distribute the discount from an initiator device.

Other objects, features, and advantages of the disclosure will be apparent from the following description, taken in conjunction with the accompanying sheets of drawings, wherein like numerals refer to like parts, elements, components, steps, and processes.

### BRIEF DESCRIPTION OF THE DRAWINGS

The features and advantages of aspects of the present invention will become more apparent from the detailed description set forth below when taken in conjunction with the claims and drawings, in which like reference numbers indicate identical or functionally similar elements.

FIG. 1 depicts a block diagram of a discount distribution system suitable for use with the methods and systems consistent with the present invention;

FIGS. 2A and 2B depict a detailed depiction of a client device and initiator device utilized in the discount distribution system of FIG. 1;

FIG. 3 is a schematic representation of the operation of the distributed discount system of FIG. 1;

FIG. 4 is a schematic representation of the operation of presenting a discount to an initiator via an initiator device included in the discount distribution system of FIG. 1;

FIG. 5 depicts a user interface listing discounts available for activation by the initiator device of FIG. 2B;

FIG. 6 depicts a custom discount configuration screen that allows an initiator to create a custom discount via the initiator device of FIG. 2B; and

FIG. 7 depicts a client interface screen that allows a client to locate a discount activated by a merchant via the client device of FIG. 2B; and

FIG. 8 depicts a client interface screen that display discounts on a map via the display on the client device of FIG. 2B.

### DETAILED DESCRIPTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

The present invention allows a merchant, or service supplier, to distribute a discount to a plurality of users. Specifically, the system allows a merchant to define and store a plurality of discounts in a storage unit, and to display a list of stored discounts to an initiator of a discount via a communication device. The initiator of the discount may distribute a discount based on observations of buying patterns, excess inventory of a specific product, or any other factor which may result in additional sales. Further, the system may automatically distribute a discount based on predefined criteria stored in the database with the discount. Activating a discount is understood to mean making a discount available to users of the system.

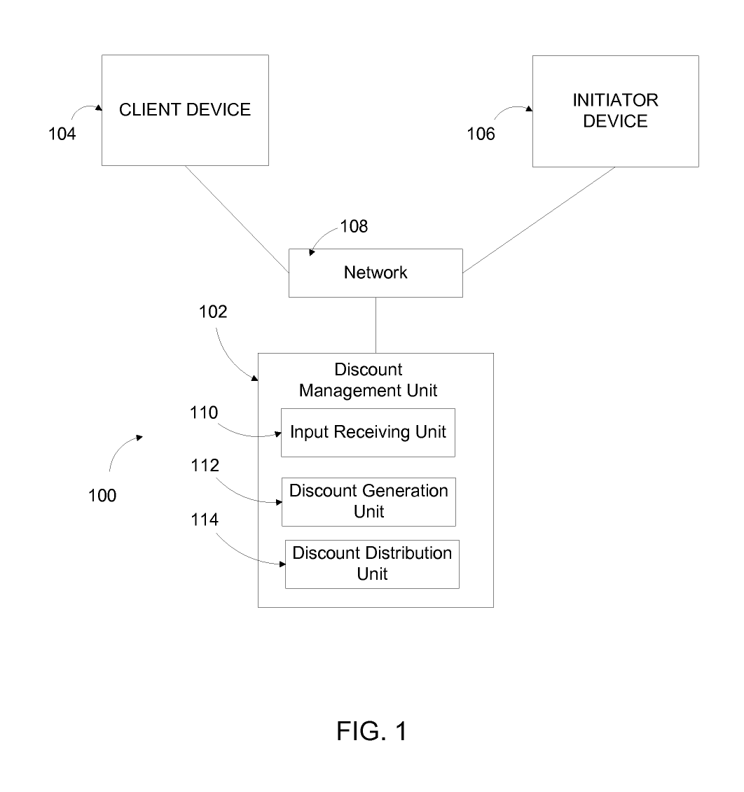

FIG. 1 depicts a block diagram of a discount distribution system 100 suitable for use with the methods and systems consistent with the present invention. The discount distribution system 100 comprises a plurality of devices such as computers 102, 104, and 106 connected via a network 108. The network 108 is of a type that is suitable for connecting the computers 102, 104, and 106 for communication, such as a circuit-switched network or a packet-switched network. Also, the network 108 may include a number of different networks, such as a local area network, a wide area network such as the Internet, telephone networks including telephone networks with dedicated communication links, connection-less network, and wireless networks. In the illustrative example shown in FIG. 1, the network is the Internet. Each of the computers 102, 104, and 106 shown in FIG. 1 is connected to the network 108 via a suitable communication link, such as a dedicated communication line or a wireless communication link.

In an illustrative example, computer 102 serves as discount management unit that includes an input receiving unit 110, discount generation unit 112, and a discount distribution unit 114. The number of computers and the network configuration shown in FIG. 1 are merely an illustrative example. One having skill in the art will appreciate that the system may include a different number of computers and networks. For example, the discount management unit 102 may include the input receiving unit 110, as well as, the discount distribution unit 112. Further, the discount generation unit 114 may reside on a different computer than discount management unit 102.

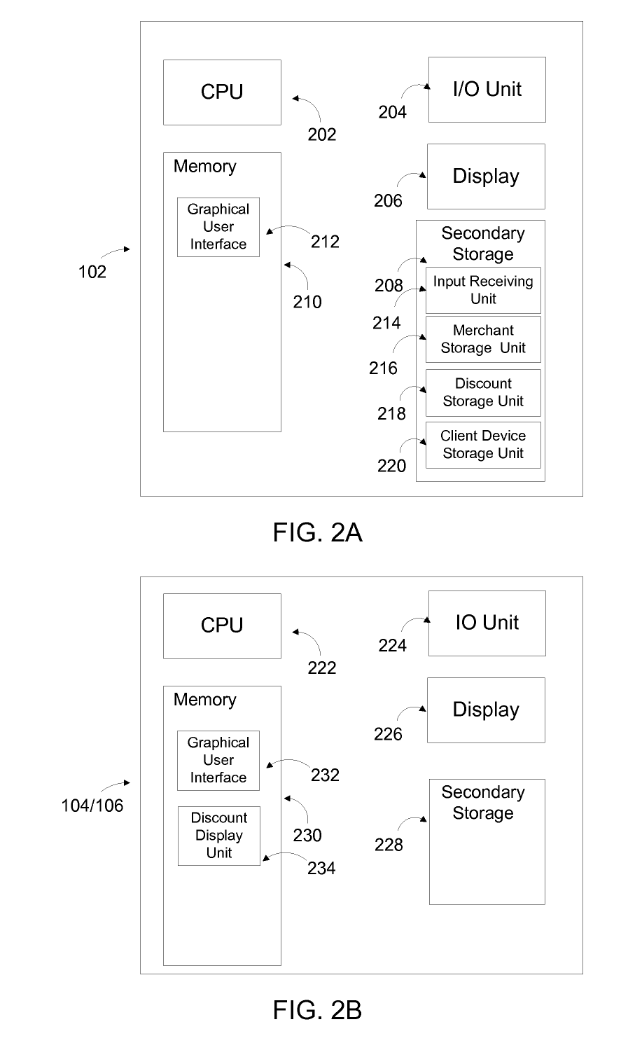

FIG. 2A shows a more detailed depiction of discount management unit 102. Discount management unit 102 comprises a central processing unit (CPU) 202, an input output (I/O) unit 204, a display device 206, a secondary storage device 208, and a memory 210. The discount management unit 102 may further comprise standard input devices such as a keyboard, a mouse, a digitizer, or a speech processing means (each not illustrated).

The discount management unit 102's memory 210 can include a Graphical User Interface (GUI) 212, which is used to gather information from a user via the display device 206 and I/O unit 204, as described herein. The GUI 212 includes any user interface capable of being displayed on a display device 206 including, but not limited to, a web page, a display panel in an executable program, or any other interface capable of being displayed on a computer screen. The secondary storage device 208 includes an input receiving unit 214, a merchant storage unit 216, a discount storage unit 218, and a client device storage unit 220. Further, the GUI 212 may also be stored in the secondary storage unit 208. In one embodiment consistent with the present invention, the GUI 212 is displayed using commercially available hypertext markup language (HTML) viewing software such as, but not limited to, Microsoft Internet Explorer, Google Chrome® or any other commercially available HTML viewing software.

FIG. 2B shows a more detailed depiction of client device 104 and the initiator device 106. Client device 104 and the initiator device 106 each comprise a central processing unit (CPU) 222, an input output (I/O) unit 224, a display device 226, a secondary storage device 228, and a memory 230. Computers 104 and 106 may each comprise standard input devices such as a keyboard, a mouse, a digitizer, or a speech processing means (each not illustrated).

The memory 230 of the client device 104 and the initiator device 106 include a GUI 232, which is used to gather information from a user via the display device 226 and I/O unit 224, and a communication service 214 used to present communications to the user operating the client device 104, or the initiator device 106, as described herein. The GUI 232 can include any user interface capable of being displayed on a display device 226 including, but not limited to, a web page, a display panel in an executable program, or any other interface capable of being displayed on a computer screen. The GUI 232 may also be stored in the secondary storage unit 228. The GUI 232 may also be displayed using commercially available HTML, as previously discussed. The memory 230 also includes a discount display unit 234, which is configured to receive a discount, or listing of discounts, to transmit to the display 226.

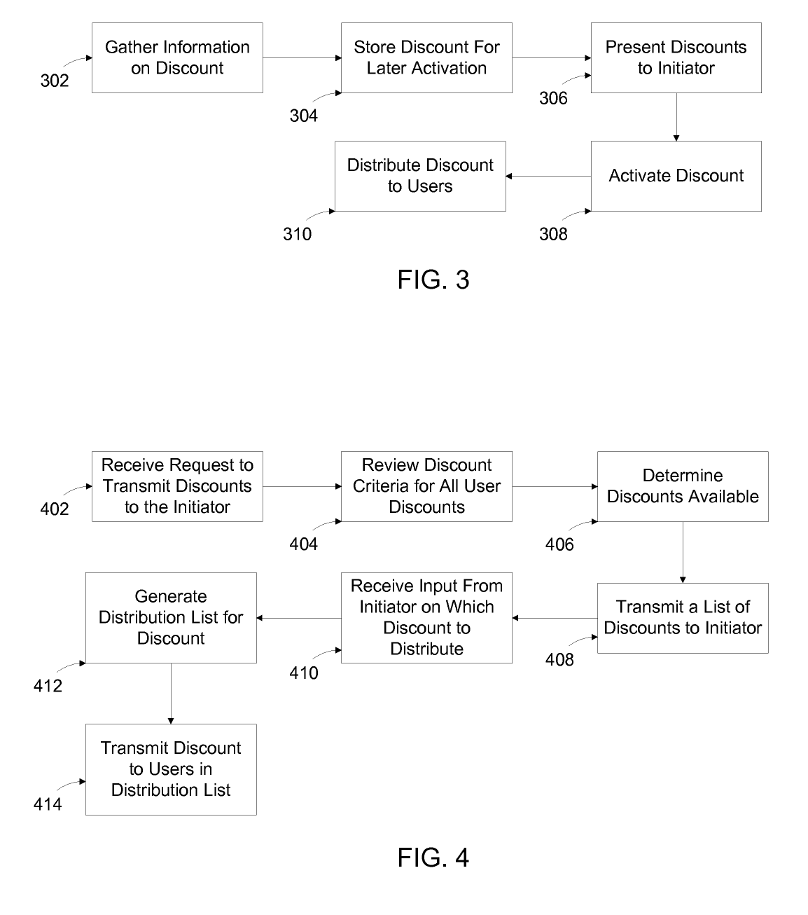

FIG. 3 is a schematic representation of the operation of a distributed discount system 100. In step 302, the discount distribution system 100 gathers information on a discount program from a user via the GUI 212. To gather the information, a merchant, or service provider, securely connects to the discount management unit 102 using any known method of logging into a system such as, but not limited to, a secure sockets layer (SSL) connection. Once an authorized connection is established, the merchant may enter information pertaining to each discount to be stored in the discount storage unit 218. The information may include, but is not limited to, the amount of the discount, locations where the discount is available, dates when the discount can be active, values which cause the distribution of the discount, values which cause the discount to end, and a listing of registered users who can initiate a discount.

In step 304, after information concerning the discount is gathered, the discount is stored in the discount storage unit 218. In step 306, a plurality of discounts selected based on a predefined criteria are presented to the initiator device 106. The initiator device 106 may be any device capable of displaying the discount, and may include a stationary computer, a laptop computer, a tablet computer, a mobile communication device, a smart phone, a cellular phone, a personal data assistant, or any other device capable of displaying the discount.

In step 308, the discount distribution system 100 distributes the selected discounts to each of the plurality of client devices 104. The client device 106 may be any device capable of displaying the discount, and may include a stationary computer, a laptop computer, a tablet computer, a mobile communication device, a smart phone, a cellular phone, a personal data assistant, or any other device capable of displaying the discount. Each of the client devices 104 notifies a user of the client devices 104 that a discount is available. The distribution of the discount to each client device 104 may be limited based on the geographic location of each client device 104, the demographics or preferences of a user of the client device 104, or any other factor defined by the merchant offering the discount.

FIG. 4 is a schematic representation of the operation of presenting a discount to an initiator via the initiator device 106. In step 402, the discount management unit 102 receives a request to transmit discounts associated with a merchant in the merchant storage unit 216, or service provider, to an initiator device 106. The distribution may be initiated by a user of the initiator device 106, or may be automatically initiated by the discount management unit 102.

In step 404, the discount generation unit 216, in the discount management unit 102, generates a list of discounts associated with the merchant from the discount storage unit 218. Each discount in the discount storage unit 218 includes criteria that indicate when a specific discount may, or may not, be activated by the initiator. The criteria may include, but are not limited to, a time period during which the discount is available, the products to which the discount applies, or any other criteria which would indicate when a discount can, or cannot, be offered. The criteria is specified by the merchant when the information is inputted into the discount storage unit 218.

The criteria may automatically adjust based on real time information gathered by the discount generation unit 112. The discount generation unit 216 may be communicatively coupled to the point of sale system for the merchant, and may receive real time sales information from a “point of sale” system. The discount generation unit 216 may identify patterns in purchasing during a sales day, and allow the initiation of different discounts based on the identified patterns. At an illustrative example, the discount generation system 216 may identify a list of products where sales decrease during a specific period of a day. In response to this decrease, the discount generation system may issue a discount on these products during the periods when the product sales are lower.

The discount generation system 112 may also generate discounts on popular items based on the number of transactions in a given period. If the number of transactions falls below a given threshold, the discount distribution system 112 may alert the initiator, and display a list of discounts on the initiator device 106 that would increase the sales of the merchant. These discounts may be determined based on historical sales data stored in the discount storage unit 218.

The discount generation unit 112 may also allow an initiator to create a customized discount. The customized discount may be stored in the discount storage unit 218 by the initiator after the initiator has configured the discount. To configure a customized discount, the discount generation system 112 transmits a series of predefined options to the initiator, which the initiator uses to generate the customized discount. Once all of the options are selected, the discount generation system 112 stores the new discount in the discount storage unit 218, and the discount is distributed in the same manner as discussed herein.

As an illustrative example, a coffee shop may create a plurality of discounts in the discount storage unit 218, along with information pertaining to a desired sales goal, or number of transactions, over a period of time. The discount generation unit 216 may monitor the sales and number of transactions occurring over the predefined period. If number of transactions over the predefined period of time is less than the predefined threshold, the discount generation unit 216 may analyze historical sales data stored in the discount storage unit 218 to determine the best selling products sold by the coffee shop. The discount generation system 216 may then present a discount on popular products, as determined from the historical sales data, to the initiator for activation.

In step 408, the discount generation unit. 112 transmits a list of discounts to the initiator device 106 via the discount distribution unit 114. In step 410, the initiator device 106 displays a list of available discounts on the display 226 of the initiator device 106. Upon receipt and display of the list of discounts, the initiator selects at least one of the discounts for activation. In response, the initiator device 106 transmits a list of the selected discounts to the discount generation unit 112. The discount generation unit 112 transmits the discount, along with distribution information, to the discount distribution unit 114. The distribution information may be information in the discount storage unit 218 that indicates specific rules for distributing the selected discount to client devices 104. As an illustrative example, the distribution information may include a list of geographic locations where the discount applies causing the discount distribution system 116 to distribute the discount to client devices 104 located near the geographic region where the discount is available. The location of the client devices may be determined using a global positioning satellite (GPS) device coupled to each client device.

In step 412, the discount distribution unit 114 analyzes the distribution information to generate a list of client devices 104, stored in the client storage unit 218, that satisfy the distribution information. Based on the distribution information, the discount distribution unit 114 may transmit an update message to each potential client device 104 to determine if a particular client device 104 satisfies the requirements included in the distribution information. As an illustrative example, the discount distribution system 114 may query a plurality of client devices 104 to determine the GPS coordinates of the client devices 104, and then apply GPS coordinates included in the distribution information to the received GPS coordinates to determine which of the plurality of client devices 104 are added to the distribution list. In step 414, the discount distribution system 114 transmits the discount to each of the client devices 104 in the distribution list for display on the displays 226 of the client devices 104.

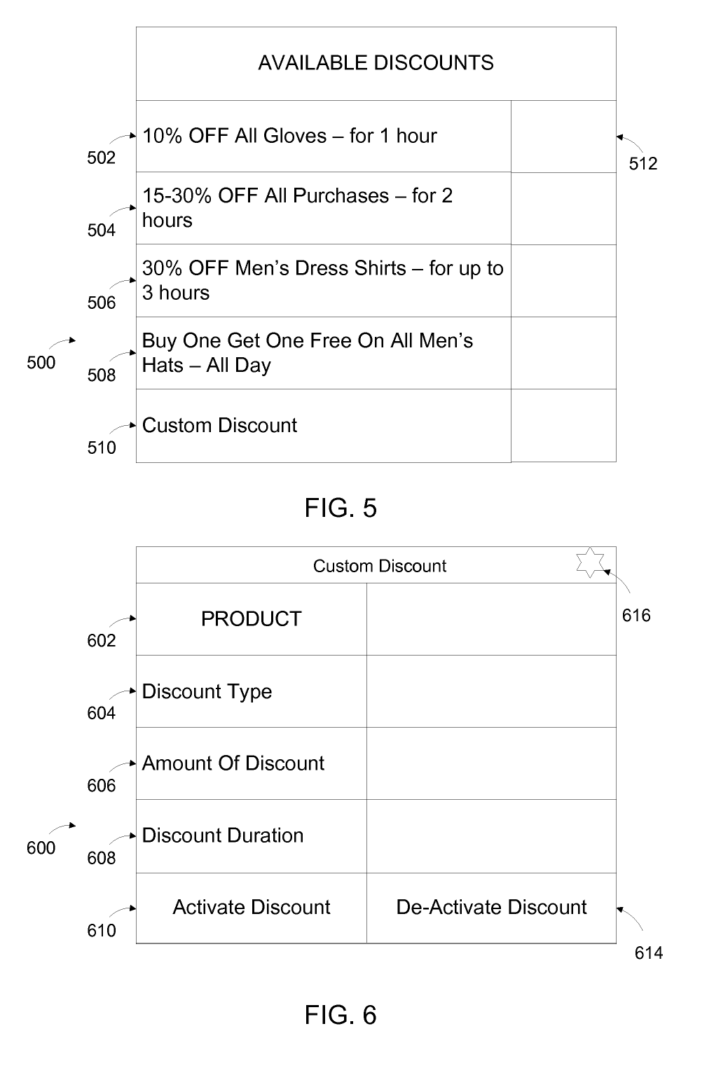

FIG. 5 depicts a user interface 500 listing discounts available for activation by the initiator device 106. The discount distribution unit 114 transmits the discount information to the discount display unit 234 on the initiator device 106. The discount display unit 234 receives the discount information and generates the user interface 500. The user interface 500 includes a listing of previously defined discounts of, for example, varying lengths and values. The discount may have a defined value and length or a variable value and length. The discount 502 depicts a discount having a fixed value and a fixed length. The exemplary discount 504 has a variable value of between 15 and 30% and a fixed length. If the discount 504 is selected, the initiator is prompted via the display 226 to select a specific percentage for the discount. If the discount 506 is selected, the initiator is prompted, via the display 226, to select a duration for the discount to remain active. If the discount 508 is selected, the discount is applied for the entire sales day, or the remaining amount of the sales day. If the discount 510 is selected, the initiator may configure a custom discount.

A discount status indicator 512 is positioned on one side of the description of the discount 502, 504, 506, 508 and 510. The discount status indicator 512 is configured to notify the initiator when a specific discount 502, 504, 506, 508 or 510 is active. The discount status indicator 512 may display a predefined color, such as green, to indicate that the discount is currently activated. The initiator may active or deactivate a discount by pressing the discount status indicator 512, which results in the discount status indicator 512 changing color to indicate the discount is no longer activated. The discount status indicator 512 may also change color to indicate the discount is no longer active when the time period of the discount has expired.

FIG. 6 depicts a custom discount configuration screen 600 that allows an initiator to create a custom discount. The discount distribution unit 114 transmits the discount information to the discount display unit 234 on the initiator device 106. The discount display unit 234 receives the discount information and generates the user interface 600. The custom discount configuration screen 600 includes a product selection area 602, a discount type selection area 604, a discount amount selection area 606, a discount duration selection area 608, an activate discount button 610, and a deactivate discount button 612.

To generate a custom discount, the initiator selects a product to discount from a list of predefined products. The predefined products are configured by the discount generation unit 112 based on the criteria inputted by the merchant. After the initiator selects a product to discount, the initiator selects the type of discount from the discount type selection area 604. The type of discount to apply to a product can be predefined by the merchant in the discount storage unit 218, or may be determined by the initiator. The type of discount may be a percentage off a product or a transaction, a fixed amount off of the price of a product, a fixed amount off the total price of a transaction, an offer to buy one of a product and get another product free, or any other discount to a product.

Once the discount type is selected, the initiator may select the value of the discount by the discount amount selection area 606. The value of the discount is selected based on the discount type selected in the discount type selection area 604. As an illustrative example, if a percentage off discount is offered, the discount amount selection area 606 is configured to only accept percentage values. Once the amount of the discount is selected, the initiator selects the time period the discount will be made available to users by the discount duration selection area 608. The duration of the discount may be in hours, days, weeks, months, or any other desired duration. In addition, the duration of the discount may be set to an open ended value where the discount remains open until the discount is de-activated.

The merchant may define a range for the discount duration, discount amount, and discount type. Further, the amount and type of discount may be restricted by the merchant based on the product selected. The merchant may store a list of products in the discount storage unit 218 and assign a discount range, duration, and type to each product. As an illustrative example, the merchant may enter a pair of men's shoes into the discount storage unit 218, along with configuration information pertaining to custom discounts applied to the shoes such as the maximum discount applied to the shoe, the maximum duration of a discount applied to the shoe, the types of discounts available for the shoe, and the locations where a custom discount may be applied. When an initiator selects the men's shoes to apply a custom discount, the discount generation unit 112 sends the custom discount configuration information to the initiator device 106 where the custom discount interface 600 is configured to restrict the configuration of the custom discount to the criteria sent from the discount generation unit 112.

The discount generation unit 112 may also restrict the discounts transmitted to the initiator device based on the user logged into the initiator device. As an illustrative example, if the initiator is a store clerk, the discount generation unit 112 may only transmit predefined discounts of fixed duration, while the discount generation unit 112 may transmit the option of initiating a custom discount if the initiator is a store manager.

To activate the discount, the initiator presses the activate button 610, which transmits the custom discount to the discount generation unit 112. The discount generation unit 112 stores the discount in the discount storage unit 218, and then sends the discount to the discount distribution unit 114. The discount distribution unit 114 generates a distribution list, and distributes the discount as previously described. The initiator can also mark discounts as favorites for quick loading, by selecting the favorite button 616 located on the custom discount configuration screen 600.

Since the application allows for the creation of discount at anytime, dynamic discounts that respond to real time merchant and client needs are possible. In addition, clients of merchants have a simple way of receiving notification of discounts offered on products by merchants in their area.

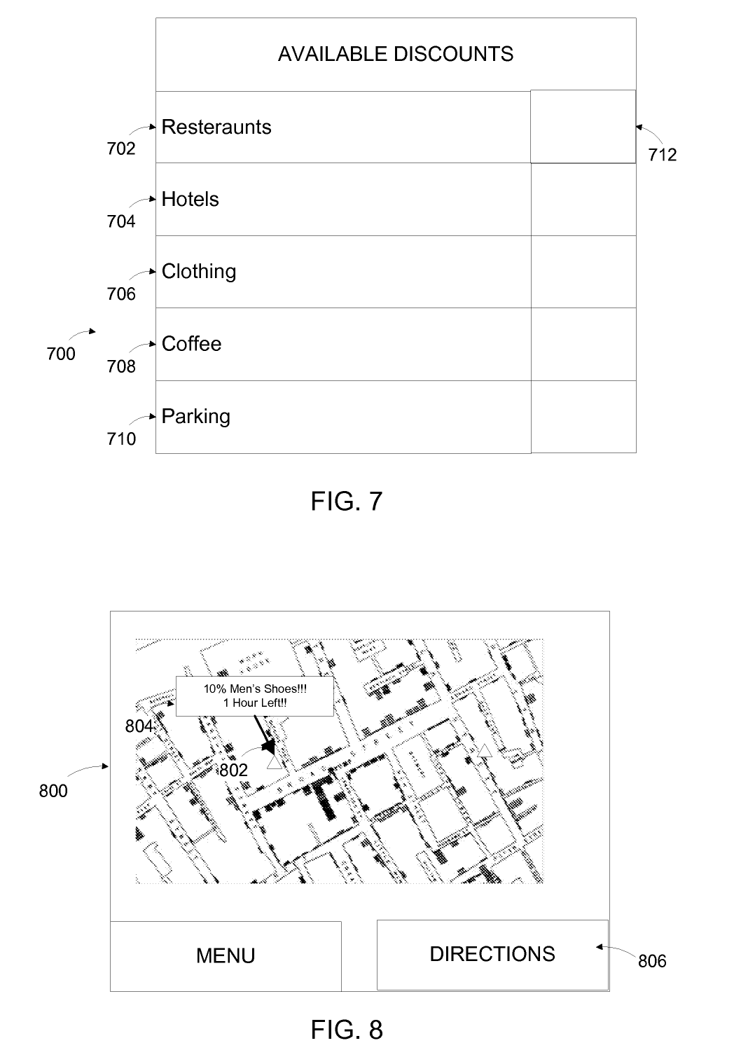

FIG. 7 depicts a client interface screen 700 that allows a client to locate a discount activated by a merchant. The discount distribution unit 114 transmits the discount information to the discount display unit 234 on the client device 104. The discount display unit 234 receives the discount information and generates the user interface 700. The discount distribution system 112 assigns a predefined category to each product, and discount, in the discount storage unit 218. The client interface screen 700 displays a list of the predefined categories 702, 704, 706, 708, and 710 on the display 226, which a user may select to view subcategories of the selected category, or discounts related to the category. The client interface screen 700 includes a discount indicator icon, which indicates if a category has a discount available. If a discount is available for a particular category, the icon for that category may turn green.

FIG. 8 depicts a client interface screen 800 that displays discounts on a map via the display 226 on the client device 104. The discount distribution unit 114 transmits the discount information to the discount display unit 234 on the client device 104. The discount display unit 234 receives the discount information and generates the user interface 800. The discount distribution unit 112 may compare the GPS information of each client device 104 to the GPS information associated with each discount to determine which discounts to distribute to each client device 104. The discount distribution system 116 may distribute discounts to each client device 104 within a predetermined distance of the client device 104. The discount display unit 234 may display a map 800 showing the location of each discount in relation to the client device 104. The location of each discount may be indicated by an icon such as a triangle. When the user selects the icon, information 804 concerning the discount appears above the icon.

The client interface screen may also allow a user to create a listing of favorite merchants. A user may select the icon associated with the discount which presents the user with the option of saving the merchant as a favorite. If the merchant is saved as a favorite, the discount display unit 234 saves the merchant name, GPS coordinates and other information concerning the merchant in the client storage unit 218 on the discount management unit 102.

After the client selects a discount on the client device 104, the client may obtain directions by pressing the directions button 806. The direction button may display turn by turn directions from the client device's current location to the merchant offering the discount. The client device 104 may use any conventional mapping software to determine the directions and route, such as Google Maps, Mapquest or any other GPS based mapping software.

As an illustrative example, consider an example of a fast food store located in a large city. The owner of the store can create a number of discounts in the discount management unit 102 which are transmitted to an initiator device 106 used by a store manager working, at the store. The store manager can review the current sales activity at the store and initiate a discount offer by selecting a predefined discount or by creating a custom discount, such as a predefined offer of free French fries with the purchase of a hamburger, or a custom discount of 50% of the regular price of a hamburger.

Once the discount is selected, the discount distribution system 226 transmits the discount to users who are identified as being potential purchases of the discounted products. The potential clients of the discounted products receive a notification via the client devices 104 indicating that a discount is being offered by a merchant in their area. The client can view the discount on the client device 104 and obtain, driving directions to the merchant offering the discount.

Because the discount management system 100 allows an initiator, such as a store manager or clerk, to activate a discount at any location via the initiator device 106, the process of creating and distributing discounts is simplified. Also, because merchants can control the amount, duration and products included in each discount, the merchant is protected from losing money due to improper judgment by an employee initiating a discount.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

What is claimed is:

1. A discount distribution system including a discount generation unit having a processor and a memory with a program executing in the memory that performs the steps of:
gathering information pertaining to a product by an information gathering unit;
generating a plurality of discounts associated with the product based on the information gathered;
storing each of the generated discounts and each of the associated product information in the memory of the discount generation unit;
displaying a plurality of selected discounts on a display on an initiator device in response to a triggering event;
distributing at least one of the plurality of selected discounts to a plurality of client devices based on a request from the initiator device.

2. The discount distribution system of claim 1 wherein the triggering event is a request from the initiator device.

3. The discount distribution system of claim 1 wherein the initiator device generates a discount and stores the discount in the discount storage unit.

4. The discount distribution system of claim 1 including the steps of
associating each selected discount with a geographical location where the discount is available;
gathering location information for each of the plurality of client devices,
wherein each selected discount is distributed to client devices based on the geographical location of each discount and the geographical location of each client device.

5. The discount distribution system of claim 3 including the steps of
transmitting a list of products to the initiator device;
associating a discount value with at least one product in the list;
associating a duration during which the discount associated with the product is available to client devices; and
transmitting the discount value and discount duration to the discount generation unit for storage in the discount storage unit.

6. The discount distribution system of claim 3 including the step of sending a discount activation signal to the discount generation unit that causes the discount generation unit to distribute the discount to a plurality of client devices.

7. The discount distribution system of claim 1 wherein at least one of the discounts is distributed to at least one client device in response to a request from the at least one client device.

8. The discount distribution system of claim 1 including the step of assigning at least one category to each of the products in the discount storage unit.

9. The discount distribution system of claim 1 wherein the client devices display each discount based on the at least one category assigned to each discount.

10. The discount distribution system of claim 1 wherein the initiator device adjusts the value or duration of a discount stored in the discount storage unit before the discount is distributed to the client devices.

11. A discount management device including:
an information gathering unit;
a discount generation unit;
a discount storage unit; and
a discount distribution unit,
wherein,
the discount generation unit generates a discount associated with a product based on information gathered from an information gathering unit, and stores the discount in the discount storage unit, and
the discount generation unit selects at least one discount in the discount storage unit based on a predefined criteria for distribution to at least one client device of a plurality of client devices in response to a request to distribute from an initiator device.

12. The discount management unit of claim 11 wherein the initiator device generates a discount and stores the discount in the discount storage unit.

13. The discount management unit of claim 11 wherein
the discount generation unit associates each discount with a geographical location where the discount is available, and
the discount generation unit gathers location information for each of the plurality of client devices, and
each discount is distributed to client devices based on the geographical location of each discount and the geographical location of each client device.

14. The discount management unit of claim 11 wherein the discount distribution unit transmits a list of products to the initiator device;
the initiator device associates a discount value with at least one product in the list;
the initiator device associates a duration during which the discount is available to client devices with the product;
the initiator device transmits the discount value and discount duration to the discount generation unit for storage in the discount storage unit.

15. The discount management unit of claim 14 wherein the initiator device transmits a discount activation signal to the discount generation unit that causes the discount generation unit to distribute the discount.

16. The discount management unit of claim 11 wherein at least one of the discounts is distributed to the client devices in response to a request from at least one client device.

17. The discount management unit of claim 11 wherein the discount generation unit categorizes each of the products in the discount storage unit.

18. The discount management unit of claim 11 wherein each of the client devices are configured to display each discount based on the category of each discount.

19. The discount management unit of claim 11 wherein the initiator device adjusts the value or duration of a discount stored in the discount storage unit before the discount is distributed to the client devices.
